(19) United States
(12) Patent Application Publication
(10) Pub. No.: US 2020/0019856 A1
(43) Pub. Date: Jan. 16, 2020

(54) SYSTEM AND METHOD FOR A GLOBAL DIGITAL ELEVATION MODEL

(71) Applicant: Climate Central, Princeton, NJ (US)

(72) Inventors: Scott A. Kulp, Kendall Park, NJ (US); Benjamin H. Strauss, Princeton, NJ (US)

(73) Assignee: Climate Central, Princeton, NJ (US)

(21) Appl. No.: 16/506,203

(22) Filed: Jul. 9, 2019

Related U.S. Application Data
(60) Provisional application No. 62/696,482, filed on Jul. 11, 2018.

(51) Int. Cl. G06N 3/08; G06N 3/04

(52) U.S. Cl. CPC G06N 3/08; G06N 3/04

(57) ABSTRACT

According to various embodiments, a neural network for performing vertical error regression analysis is disclosed. The neural network includes an input layer including input data related to a target pixel, a target location, a slope at the target location, population density at the target location, tree canopy height at the target location, vegetation density at the target location, and an Ice, Cloud, and Land Satellite (ICESat) differential map at the target location. The neural network further includes a plurality of hidden layers connected to the input layer, where the plurality of hidden layers is configured to iteratively analyze the input data. The neural network also includes an output layer connected to the plurality of hidden layers, where the output layer is configured to output a predicted vertical error based on the analysis of the input data.

### CROSS-REFERENCE TO RELATED APPLICATIONS

This application claims priority to provisional applications 62/696,482, filed Jul. 11, 2018, which is herein incorporated by reference in its entirety.

### FIELD OF THE INVENTION

The present invention relates generally to digital elevation models and, more particularly, to coastal digital elevation models improved by neural networks.

### BACKGROUND OF THE INVENTION

Accurate elevation data is crucial in assessing the risks of sea level rise, coastal flooding, and tsunamis to coastal nations and communities for humanitarian, insurance, city planning and many other purposes. While high-quality lidar-derived digital elevation models (DEMs) are freely available in a small number of countries, such as the United States, most non-US and global flood exposure analyses depend on lower-accuracy DEMs, such as NASA's Shuttle Radar Topography Mission (SRTM). However, SRTM is known to contain large errors with a positive bias, in part due to vegetation and urban development. These errors cause SRTM data to systematically underpredict population exposure to coastal flooding by as much as 60%, depending on the water height. Gross underestimation in such risk assessments make mitigation and adaptation policy decisions more difficult and less informed.

A number of studies have attempted to correct elevation errors present in SRTM, typically through a regression analysis based on a small number of variables. Recent examples have used canopy height and vegetation cover indices to estimate and remove errors caused by trees. However, these approaches apply mostly to regions of high vegetation density, where population densities are likely low, and should therefore be less useful in coastal population exposure assessments, where built structures influence SRTM values.

Incorporating additional variables that correlate with SRTM error into the model could further improve correction results. However, the curse of dimensionality, together with highly nonlinear relationships between variables, limits the practicality of traditional parametric regression techniques as more variables are added.

As such, there is a need for a system and method to obtain accurate elevation data that addresses the issues described above.

### SUMMARY OF THE INVENTION

According to various embodiments, a neural network for performing vertical error regression analysis is disclosed. The neural network includes an input layer including input data related to a target pixel, a target location, a slope at the target location, population density at the target location, tree canopy height at the target location, vegetation density at the target location, and an Ice, Cloud, and Land Satellite (ICESat) differential map at the target location. The neural network further includes a plurality of hidden layers connected to the input layer, where the plurality of hidden layers is configured to iteratively analyze the input data. The neural network also includes an output layer connected to the plurality of hidden layers, where the output layer is configured to output a predicted vertical error based on the analysis of the input data.

According to various embodiments, a method for performing vertical error regression analysis with a neural network is disclosed. The method includes inputting data into an input layer of the neural network. The input data is related to a target pixel, a target location, a slope at the target location, population density at the target location, tree canopy height at the target location, vegetation density at the target location, and an Ice, Cloud, and Land Satellite (ICESat) differential map at the target location. The method further includes iteratively analyzing the input data via a plurality of hidden layers connected to the input layer. The method also includes outputting a predicted vertical error based on the analysis of the input data via an output layer connected to the plurality of hidden layers.

According to various embodiments, a non-transitory computer-readable medium having stored thereon a computer program for execution by a processor configured to perform a method for vertical error regression analysis with a neural network is disclosed. The method includes inputting data into an input layer of the neural network. The input data is related to a target pixel, a target location, a slope at the target location, population density at the target location, tree canopy height at the target location, vegetation density at the target location, and an Ice, Cloud, and Land Satellite (ICESat) differential map at the target location. The method further includes iteratively analyzing the input data via a plurality of hidden layers connected to the input layer. The method also includes outputting a predicted vertical error based on the analysis of the input data via an output layer connected to the plurality of hidden layers.

Various other features and advantages will be made apparent from the following detailed description and the drawings.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only exemplary embodiments of the invention and are not, therefore, to be considered to be limiting its scope, the invention will be described and explained with additional specificity and detail through the use of the accompanying drawings, in which:

FIG. 1 depicts a block diagram of a system for CoastalDEM® according to an embodiment of the present invention;

FIG. 2 depicts a flowchart visualization of adjustment system architecture according to an embodiment of the present invention;

FIG. 3(a) depicts testing set error rates plotted against six data sets (ground-truth lidar elevation (target elevation), population density, land slope, local ICESat error, canopy height, and vegetation density), before and after adjustment in USA according to an embodiment of the present invention;

FIG. 3(b) depicts testing set error rates plotted against six data sets (ground-truth lidar elevation (target elevation), population density, land slope, local ICESat error, canopy height, and vegetation density), before and after adjustment in Australia according to an embodiment of the present invention;

FIG. 4 depicts samples of lidar elevation, original SRTM, and corrected SRTM elevation in Charleston, S.C. and Brisbane, Australia according to an embodiment of the present invention;

FIG. 5 depicts elevation error in original SRTM (top), and corrected SRTM in Charleston, S.C. and Brisbane, Australia at elevations between 1 m and 20 m according to an embodiment of the present invention;

FIG. 6 depicts samples of population density, canopy height, and vegetation density in Charleston, S.C. and Brisbane, Australia according to an embodiment of the present invention; and

FIG. 7 depicts median SRTM deviations from ICESat measurements at elevations from 1 m through 20 m over 1-degree cells worldwide, both before correction and after according to an embodiment of the present invention.

### DETAILED DESCRIPTION OF THE INVENTION

Positive vertical bias in elevation data derived from NASA's Shuttle Radar Topography Mission (SRTM) is known to cause substantial underestimation of coastal flood risks and exposure. Previous attempts to correct SRTM elevations have used regression to predict vertical error from a small number of auxiliary data products, but these efforts have been focused on reducing error introduced solely by vegetative land cover.

As such, generally disclosed herein is a multilayer perceptron artificial neural network to perform a 23-dimensional vertical error regression analyses, where in addition to vegetation cover indices, additional variables are used including neighborhood elevation values, population density, land slope, and local SRTM deviations from ICESat altitude observations. Using lidar data as ground truth, the neural network is trained on samples of US data from 1-20 m of elevation according to SRTM, and outputs are assessed with extensive testing sets in the US and Australia.

The adjustment system reduces mean vertical bias in the coastal US from 3.67 m to less than 0.01 m, and in Australia from 2.49 m to 0.11 m. RMSE is cut by roughly one-half at both locations, from 5.36 m to 2.39 min the US, and from 4.15 m to 2.46 in Australia. Using ICESat data as a reference, it is estimated that global bias falls from 1.88 m to −0.29 m, and RMSE from 4.28 m and 3.08 m. Embodiments of the system and method presented here are flexible and effective, and can be effectively applied to land cover of all types, including dense urban development. The resulting enhanced global DEM (referred to herein as CoastalDEM®) promises to greatly improve the accuracy of sea level rise and coastal flood analyses worldwide.

System Overview

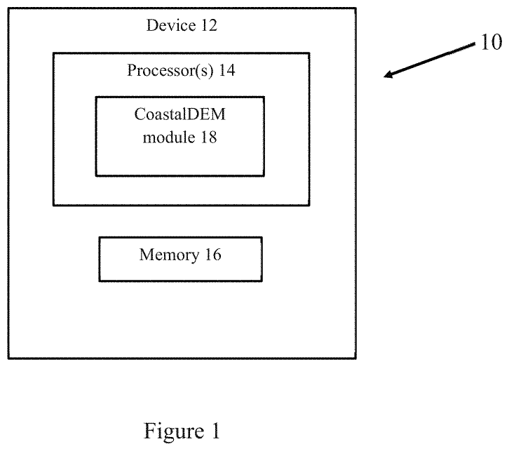

FIG. 1 illustrates a system 10 configured to implement CoastalDEM®. The system 10 includes a device 12. The device 12 may be implemented in a variety of configurations including general computing devices such as but not limited to desktop computers, laptop computers, tablets, network appliances, and the like. The device 12 may also be implemented as a mobile device such as but not limited to a mobile phone, smart phone, smart watch, or tablet computer. The device 12 can also include network appliances and Internet of Things (IoT) devices as well such as IoT sensors. The device 12 includes one or more processors 14 such as but not limited to a central processing unit (CPU), a graphics processing unit (GPU), or a field programmable gate array (FPGA) for performing specific functions and memory 16 for storing those functions. The processor 14 includes a CoastalDEM module 18 for performing multi-dimensional vertical error regression analyses. The CoastalDEM module 18 methodology will be described in greater detail below.

It is also to be noted the training process for CoastalDEM® may be implemented in a number of configurations with a variety of processors (including but not limited to central processing units (CPUs), graphics processing units (GPUs), and field programmable gate arrays (FPGAs)), such as servers, desktop computers, laptop computers, tablets, and the like.

Methodology

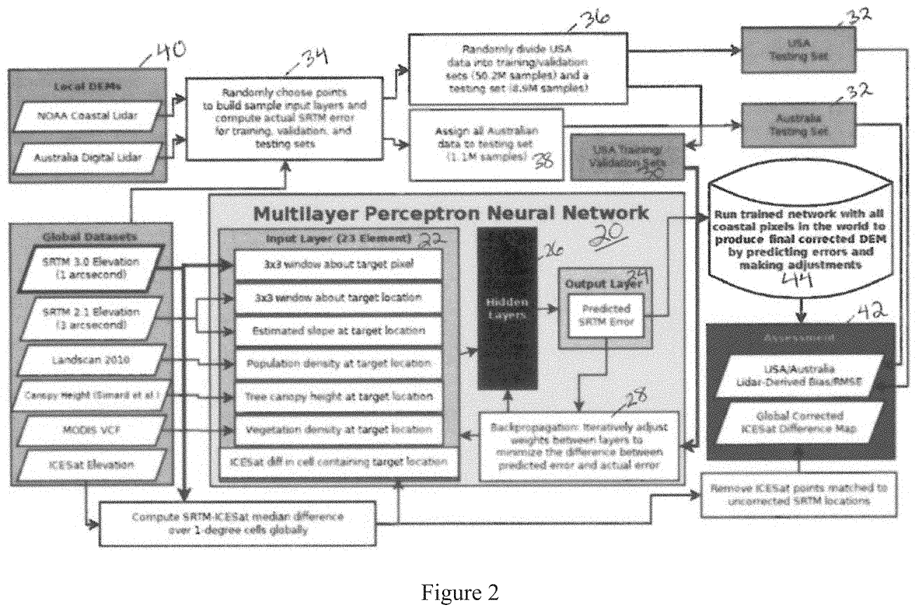

FIG. 2 depicts a flowchart visualization of adjustment system architecture according to an embodiment of the present invention. Global datasets, including SRTM 3.0, 2.1, Landscan, ICESat, and two vegetation indices, are used to make input samples to the neural network. Locallidar DEM's in the US and Australia are used to build training, validation, and testing sets with known actual SRTM error. After training, the system adjusts all coastal pixels in the world, and performance is assessed through US and Australia testing sets, as well as global ICESat measurements.

Neural Network Synthesis and Architecture

An artificial neural network (ANN, or NN) is a nonparametric computational model that can be used to automatically learn complex, highly nonlinear relationships between any number of different variables. Flexible and powerful, artificial neural networks are valuable tools in a wide variety of contexts, such as image processing and classification, audio denoising, financial market forecasting, and natural language processing.

Loosely inspired by the human brain, a multilayer perceptron (MLP) neural network 20 is made up of layers of nodes, or units, arranged in a directed weighted graph. The units in one layer are connected to the units in the next layer, starting with a single input layer 22 and ending with a single output layer 24, and some number of intermediate (“hidden”) layers 26 between them. The sizes of the input layers 22 and output layers 24 are strictly decided by the dimensionality of data (embodiments here use a 23-unit input layer for each of the 23 variables, and a 1-unit output layer for predicted SRTM error), while the number and sizes of hidden layers 26 are hyperparameters that largely depend on the complexity of the problem. Weights between units are learned through iterative backpropagation 28 using a training set 30 of samples with known answers, with the goal of minimizing the difference between predictions and actual answers. A separate validation set 30 of samples is used, as is typical, in deciding when to halt training.

Hyperparameters were selected through a manual search, in order to find settings that optimize both training time and performance of the training and validation sets 30. A preferred embodiment of the neural network for the present invention contains 3 hidden layers, with 10, 20, and 10 hidden units respectively. A Levenberg-Marquardt process is used for error minimization during backpropagation, and MSE for cost function.

It is to be noted that other neural networks aside from an MLP may implement the present invention.

Neural Network Input Layer 22

Given a (1-arcsecond) SRTM target pixel, a 23-dimensional vector is encoded as input into the neural network 20. This vector is made up of 9 values from SRTM 3.0 (1 arcsecond), 9 values from SRTM 2.1 (3 arcsecond), estimated slope, population density, a local ICESat error rate, tree canopy height, and vegetation density, each described further below. To avoid artifacts caused by inconsistent horizontal resolutions across inputs, every variable whose source resolution is less than 1 arcsecond is upsampled using linear interpolation to 1 arcsecond.

SRTM:

SRTM is a digital elevation model with nearly global coverage, based on a NASA satellite mission in February 2000. This data is available at both 3 arcsec (SRTM 2.1) and 1 arcsec (SRTM 3.0) horizontal resolutions, each with vertical resolution of 1 m, and a vertical RMSE <10 m. SRTM is an unclassified (“surface”) elevation model, meaning vegetation and tall buildings are expected to introduce significant positive bias relative to bare earth elevation, the key quantity needed for flood modeling.

Given a pixel targeted for correction in SRTM 3.0, the first 9 elements of the input vector are made of the 3×3 window including and surrounding that pixel. This provides the neural network 20 with a sampling of the elevation distribution in the immediate area. Another 9 elements of the input come from SRTM 2.1—providing similar information, but at a 3× larger scale. Since SRTM 2.1 is interpolated from 3-arcsecond to 1-arcsecond resolution, these 9 values are sampled about the target location with a stride length of 3 pixels.

Slope:

SRTM error is strongly correlated with land slope, so this gradient is an important variable for the regression. To improve accuracy and reduce the impact of noise in estimating the derivative, a wide 7-tap filter is used about the target pixel in SRTM 2.1 to compute the slope magnitude in both north and east directions. These are converted to a total angle of inclination, which we use as an input into the neural network 20.

Population Density:

High population density may be an indicator of urban development, which is known to introduce positive errors to SRTM elevation. Population density is included at the target pixel as a neural network input, computed using a 2010 Landscan dataset, which estimates ambient population in 1 km square cells. This data is refined using a SRTM Water Body Dataset (SWBD), which defines land cells at 1-arcsecond resolution. Landscan is resampled at 1-arcsecond resolutions to align with the SRTM grids, assuming zero population on water cells, while proportionally increasing the population density on land cells to ensure total population in each 1 km square remains unchanged. Landscan 2010 is chosen instead of 2000 because of the former dataset's higher quality, and the expectation that one decade of development generally represents a small change compared to the background.

ICESat:

Altitude and roll adjustments made by the SRTM shuttle produced low frequency errors (on the horizontal scale of hundreds of kilometers) across Earth's surface. Here, land surface elevation data is used from NASA's ICESat (Ice, Cloud, and land Elevation Satellite) mission to create a global error surface. ICESat was conducted by NASA between 2003 and 2010, and used the Geoscience Laser Altimeter System (GLAS) to take measurements of ice sheet thickness, vegetation cover, and land elevation, among other variables. Observation points have 70 m wide footprints, and are separated by a linear distance of 172 m. Elevation vertical accuracy varies depending on factors such as land slope, terrain type, and cloud cover, but is generally considered to be more accurate than SRTM, with mean height differences from lidar of −0.33 m (lσ: 2.87 m) over flat areas, and +5.8 m (lσ: 9.48 m) over forests. In the target 1-20 m elevation band in the US, mean ICESat-lidar bias of 1.0 m and RMSE of 5.4 m are computed.

A 1-degree mean SRTM-ICESat differential map is used, which employs the GLA14 (centroid land surface altimetry) data product, while filtering out low-quality points in mountains and forests. The estimated ICESat error at a target pixel is then included as a variable in the NN input layer 22.

Vegetation:

Improving SRTM includes reducing errors correlated with forest cover. To this end, canopy height and vegetation density maps are employed. The values of both of these rasters at a target pixel are used as inputs into the neural network 20.

Training and Testing with Lidar

Training and testing datasets 32 are derived from the coasts of the contiguous United States and Australia, as nonlimiting examples. Pixels targeted for adjustment should be limited, as it was empirically found that both training time and optimal NN architecture size grow considerably as the range of possible inputs widens. Here, the concentration is on 1-arcsecond land pixels ≥1 m and ≤20 m elevation which, given published SRTM error (<10 m), should cover the vast majority of the low elevation coastal zone (land below 10 m). Each pixel has a 1/100 probability of being chosen as a sample as shown by step 34, and the resulting 59.3 million US data samples are randomly split into training (70%), validation (15%), and testing (15%) sets as shown by step 36. Random noise is added to the input variables of the training set to avoid memorization and overfitting. All 1.1 million Australia data samples are kept as a second testing set as shown by step 38.

For each sample, a desired output is computed, SRTM elevation error. To assess this error in the US and Australia, high-quality elevation models 40 are employed based on lidar as a baseline topography (ground truth). In the United States, NOAA maintains and makes publicly available a collection of lidar-derived coastal-area DEMs, generated by a range of governmental sources and collected since 1996. These data are classified to measure bare earth elevation, and have a roughly 5 m horizontal resolution. Most datasets have published vertical errors <20 cm RMSE.

To alleviate the concerns of overfitting in the United States, the secondary Australian testing set 32 is used to further validate the methodology. Here, error is computed with an Australian lidar-based DEM, recently released by Geoscience Australia (2015). These data were collected between 2001 and 2015, and cover most of the eastern coast between Queensland and South Australia, along with a few isolated locations along the coasts of Western Australia and the Northern Territory. This DEM is also classified for bare earth, has 25 m horizontal resolution, and has <16 cm vertical RMSE.

While SRTM is vertically referenced to the EGM96 geoid, the US and Australian lidar datasets are referenced to the NAVD88 and AHD geoids, respectively. Both of the lidar DEMs are converted to EGM96, and then median resampling is used to convert them to a 1-arcsecond horizontal resolution and align them with the SRTM grid, thereby allowing simple raster subtraction to compute pixel-by-pixel SRTM error.

The resulting training, validation, and testing sets are each individually represented by an input matrix of size N×23 and a desired output vector of length N, where N is the number of samples in the dataset. These sets are fed into the adjustment system 42 and used as presented in FIG. 2 to train and assess the performance of the neural network 20.

Global Correction and Assessment

The trained neural network 20 is applied to every coastal pixel in the 1-20 m SRTM domain in the world as shown by step 44. As a final assessment, ICESat elevations are used to compute median error in stratified 1-degree cells globally, only using points that exist on corrected SRTM pixels.

It was found that the density of ICESat data varies by orders of magnitude across the global coastline, with about 10% of 1-deg cells containing more than 5000 points, and another 10% of cells containing fewer than 10. To reduce outliers, cells with fewer than 100 observations points are removed from the elevation band.

Of course, since ICESat is used as an input to one variable in the regression model, this is not a complete independent validation, but more precisely viewed as a qualitative check on the regional and global consistency of the neural network's performance.

Results

Testing Set Assessments

After correction, testing set bias is reduced from 3.67 m to less than 1 cm in the United States, and from 2.49 m to 0.11 in Australia. RMSE in the testing sets drops from 5.36 m to 2.39 m in the US, and from 4.15 m to 2.46 m in Australia. LE90, another metric often used in evaluating DEM's, falls from 9.12 m to 3.90 m in the US, and from 6.76 m to 3.94 m in Australia. In both countries, bias is virtually eliminated, while RMSE and LE90 are reduced by a factor of approximately ½.

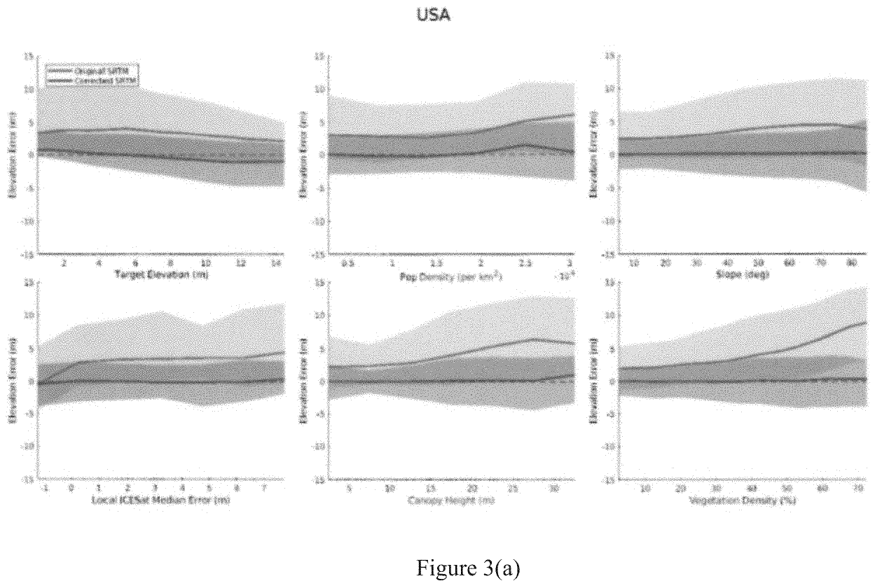

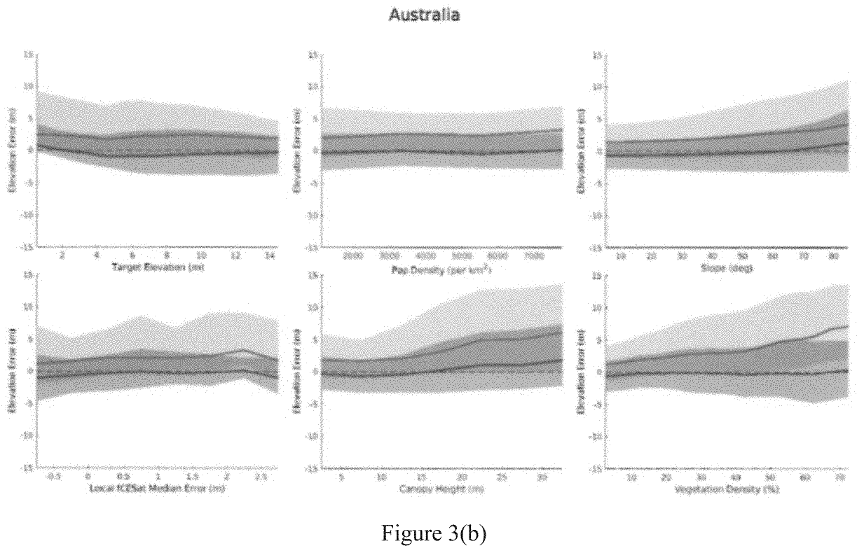

Pre- and post-correction error rates of the testing sets are then assessed as a 1D function of different data sets, including ground-truth lidar elevation, population density, land slope, local ICESat error, canopy height, and vegetation density to both justify selection of the latter five of these as inputs, and to evaluate neural network performance at removing these sources of error, as shown by FIGS. 3(a) and 3(b). In the plots of each the input variables (especially in wider ranges present in the US), it can be seen that the curves trending upward (original SRTM error) suggest positive correlation. It is then found that the flat and at nearly zero curves (adjusted DEM error) demonstrate that errors are no longer correlated with these variables. The neural network substantially reduces both median error and its variance as caused by these variables in both countries, and large improvements span the full range of elevations. In particular, the 5th-95th percentile spread at the lowest lidar elevations—land most vulnerable to coastal flooding—is cut by over one-half.

Sample Test Cases

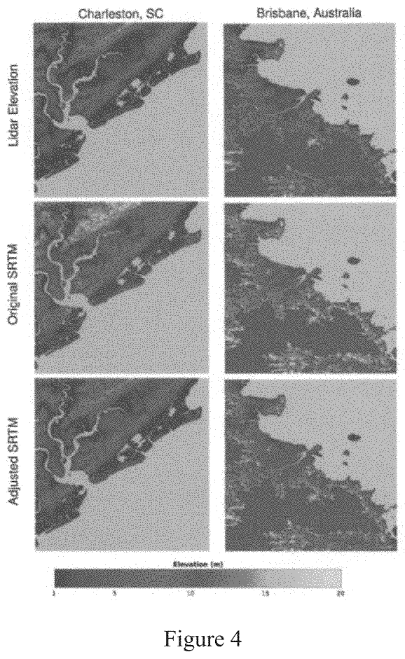

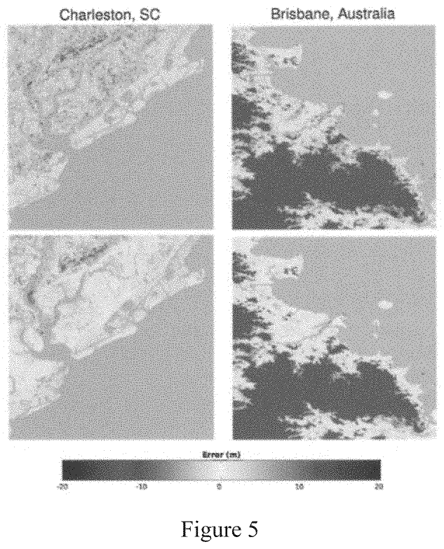

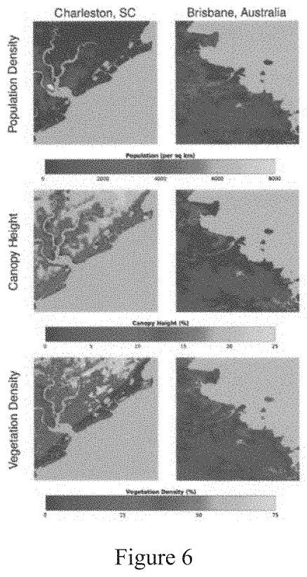

Samples from the final improved OEM in Charleston, S.C. and Brisbane, Australia, shown in FIG. 4, qualitatively suggest that the neural network flattens high frequency error in SRTM (reduces noise) and substantially reduces elevation in areas of large, positive error. A corresponding elevation error map of Charleston, shown in FIG. 5, again suggests that SRTM struggles the most with areas of high population density, as seen in parts of FIG. 6, and places of dense and tall vegetation. The correction system performs well in both contexts, with clear, substantial improvements across the whole region. The system mostly ignores (slightly improves) the wide, flat, bare band of land east of Charleston. This suggests that the neural network is not strictly reducing elevations to reduce overall bias to zero, but rather has learned appropriate levels of correction, depending on both topology and development/vegetation density. Brisbane (shown in FIGS. 4-6) is a more challenging area, due to its steeper land and high error in SRTM. Even so, the error rates in Brisbane are clearly improved along the coast, in areas of both high and low population/vegetation density and development.

ICESat Assessment

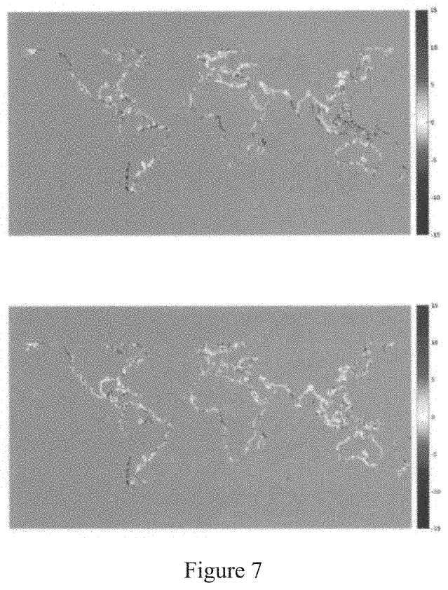

The ICESat-baselined global error maps are presented in FIG. 7. Approximately 68% of 1 degree cells see median absolute error reduced. Performance varies spatially, with apparent overcompensation more common in areas where original SRTM deviations are small or negative, such as parts of northern Africa, northern Europe, and northeast Asia. Stratified median global bias is reduced from 1.90 m to −0.24 m (an 87% improvement), and stratified RMSE is reduced from 4.17 m to 3.10 m (a 26% improvement). For comparison, evaluating US cells alone, bias decreases from 1.69 m to −0.72 m and RMSE drops from 3.03 m to 2.61 m.

### CONCLUSION

The very similar reductions shown in bias and RMSE after adjustment in both the U.S. and Australia suggest that this neural network is generalizable across continents, and not over-fitting on the US-based, northern hemisphere training set. The worldwide improvement seen in the ICESat assessment corroborates this conclusion, though the neural network struggles in certain areas where SRTM is already underestimating elevation.

Unadjusted SRTM bias and RMSE rates presented here are lower than what has been published in previous studies. This is due to our singular interest in the low elevation coastal zone. Recalling that SWDB is used to eliminate all water pixels from the domain, and noting that coastal locations of true elevation ≤0 m have very high probability of being covered by water, SRTM rarely overestimates elevation by an amount greater than its reported elevation. That is, if a coastal land pixel has SRTM elevation of 1 m, it is unlikely for error to exceed +1 m (corresponding to a true elevation 0 m or below), since it is not covered by water. This narrows the potential error distribution for those low-lying areas, reducing RMSE and positive bias in these bands.

In order to limit the likelihood and severity of the neural network extrapolation, all inputs are clamped to the same ranges as those seen in the training set. Some inadvertent extrapolation may still occur if new inputs are still outside the training set convex hull, a potential source of adjustment error. Unfortunately, this clamping also limits the system's responsiveness to extremes in certain inputs, such as very high population densities seen in cities such as Shanghai, or large SRTM deviations from ICESat experienced in southeast Asia. Additional training sets in such regions could expand the convex hull, though this would require more lidar data in these countries to serve as ground truth.

Here, a multilayer perceptron neural network model is used to prove the effectiveness of such a method in improving a DEM. More specialized, sophisticated neural network models could allow for deeper and more abstract pattern learning. Further, due to computational resource limitations, a relatively small number of hidden layers and nodes were chosen in the network. Empirical results suggest that modest changes to the current architecture do not notably impact performance. Additional variables, such as land use and building height, might further improve performance

As such, generally disclosed herein is a neural network correction model to make analysis of global sea level rise and coastal flooding exposure more achievable by essentially eliminating elevation bias and cutting RMSE by about 50% in coastal regions, as indicated by tests in areas with available high-quality ground truth data. This offers flexibility in input parameters, and can be re-applied to improve future global DEM releases from NASA or other sources. Additionally, performance improvements are not limited to forested regions, as were previous SRTM enhancement efforts, but rather work across all types of land cover, including urban areas. With these improvements, the corrected global coastal elevation model presented here should be a valuable asset for next-generation flood risk modeling projects.

It is understood that the above-described embodiments are only illustrative of the application of the principles of the present invention. The present invention may be embodied in other specific forms without departing from its spirit or essential characteristics. All changes that come within the meaning and range of equivalency of the claims are to be embraced within their scope. Thus, while the present invention has been fully described above with particularity and detail in connection with what is presently deemed to be the most practical and preferred embodiment of the invention, it will be apparent to those of ordinary skill in the art that numerous modifications may be made without departing from the principles and concepts of the invention as set forth in the claims.

What is claimed is:

1. A neural network for performing vertical error regression analysis, the neural network comprising:
an input layer comprising input data related to a target pixel, a target location, a slope at the target location, population density at the target location, tree canopy height at the target location, vegetation density at the target location, and an Ice, Cloud, and Land Satellite (ICESat) differential map at the target location;
a plurality of hidden layers connected to the input layer, the plurality of hidden layers configured to iteratively analyze the input data; and
an output layer connected to the plurality of hidden layers, the output layer configured to output a predicted vertical error based on the analysis of the input data.

2. The neural network of claim 1, wherein the plurality of hidden layers is configured to iteratively analyze the input data by adjusting weights between the hidden layers to minimize a difference between the predicted vertical error and an actual vertical error.

3. The neural network of claim 2, wherein the weights between the hidden layers are adjusted based on a training set of known vertical error.

4. The neural network of claim 2, wherein adjusting the weights between the hidden layers is halted based on a validation set of known vertical error.

5. The neural network of claim 1, wherein the plurality of hidden layers comprises three hidden layers with ten, twenty, and ten hidden units, respectively.

6. The neural network of claim 1, wherein the input layer comprises 23 units corresponding to 23 variables of the input data.

7. The neural network of claim 1, wherein the output layer comprises one unit.

8. The neural network of claim 1, wherein the neural network comprises a multilayer perceptron neural network.

9. A method for performing vertical error regression analysis with a neural network comprising:
inputting data into an input layer of the neural network, the input data being related to a target pixel, a target location, a slope at the target location, population density at the target location, tree canopy height at the target location, vegetation density at the target location, and an Ice, Cloud, and Land Satellite (ICESat) differential map at the target location;
iteratively analyzing the input data via a plurality of hidden layers connected to the input layer; and
outputting a predicted vertical error based on the analysis of the input data via an output layer connected to the plurality of hidden layers.

10. The method of claim 9, further comprising iteratively analyzing the input data by adjusting weights between the hidden layers to minimize a difference between the predicted vertical error and an actual vertical error.

11. The method of claim 10, wherein the weights between the hidden layers are adjusted based on a training set of known vertical error.

12. The method of claim 10, wherein adjusting the weights between the hidden layers is halted based on a validation set of known vertical error.

13. The method of claim 9, wherein the plurality of hidden layers comprises three hidden layers with ten, twenty, and ten hidden units, respectively.

14. The method of claim 9, wherein the input layer comprises 23 units corresponding to 23 variables of the input data.

15. A non-transitory computer-readable medium having stored thereon a computer program for execution by a processor configured to perform a method for vertical error regression analysis with a neural network, the method comprising:
inputting data into an input layer of the neural network, the input data being related to a target pixel, a target location, a slope at the target location, population density at the target location, tree canopy height at the target location, vegetation density at the target location, and an Ice, Cloud, and Land Satellite (ICESat) differential map at the target location;
iteratively analyzing the input data via a plurality of hidden layers connected to the input layer; and
outputting a predicted vertical error based on the analysis of the input data via an output layer connected to the plurality of hidden layers.

16. The computer-readable medium of claim 15, further comprising iteratively analyzing the input data by adjusting weights between the hidden layers to minimize a difference between the predicted vertical error and an actual vertical error.

17. The computer-readable medium of claim 16, wherein the weights between the hidden layers are adjusted based on a training set of known vertical error.

18. The computer-readable medium of claim 16, wherein adjusting the weights between the hidden layers is halted based on a validation set of known vertical error.

19. The computer-readable medium of claim 15, wherein the plurality of hidden layers comprises three hidden layers with ten, twenty, and ten hidden units, respectively.

20. The computer-readable medium of claim 15, wherein the input layer comprises 23 units corresponding to 23 variables of the input data.
